(19) United States
(12) Patent Application Publication
(10) Pub. No.: US 2023/0138152 A1
(43) Pub. Date: May 4, 2023

(54) APPARATUS AND METHOD FOR GENERATING VALID NEURAL NETWORK ARCHITECTURE BASED ON PARSING

(71) Applicant: SAMSUNG SDS CO., LTD., Seoul (KR)

(72) Inventors: Suk Hoon Jung, Seoul (KR); Sung Yoon Kim, Seoul (KR); Da Seul Bae, Seoul (KR); Young Jun Kim, Seoul (KR); Jae Sun Shin, Seoul (KR)

(21) Appl. No.: 17/973,893

(22) Filed: Oct. 26, 2022

(30) Foreign Application Priority Data
Oct. 28, 2021 (KR) 10-2021-0145174

(51) Int. Cl. G06N 3/04; G06N 3/08

(52) U.S. Cl. CPC G06N 3/04; G06N 3/082

(57) ABSTRACT

An apparatus for generating a valid neural network architecture includes one or more processors, and a memory storing one or more programs which are configured to be executed by the one or more processors. The one or more programs include instructions for a neural network architecture parser and a neural network architecture generator, which the a neural network architecture parser configured to generate one or more abstract syntax trees corresponding to neural network architectures, respectively, by parsing one or more neural network architectures; and a neural network architecture generator configured to generate one or more new neural network architectures by substituting at least a portion of blocks of the abstract syntax tree with blocks compatible with the partial regions.

### CROSS-REFERENCE TO RELATED APPLICATION AND CLAIM OF PRIORITY

This application claims the benefit under 35 USC § 119 of Korean Patent Application No. 10-2021-0145174, filed on Oct. 28, 2021 in the Korean Intellectual Property Office, the disclosure of which is incorporated herein by reference in its entirety.

### BACKGROUND

### 1. Field

Example embodiments of the present disclosure relate to a neural architecture search.

### 2. Description of Related Art

Recently, as the demand for AI application services has exploded, AutoML technology for automating creation of a machine learning model has drawn great attention. In particular, in the field of deep learning, research related to neural architecture search (NAS) for automatically constructing a neural network suitable for target data has been actively conducted.

Generally, NAS may have three main components, a search space, a search method, and an evaluation method. The search space may be defined as a generation rule of a candidate neural network architecture to be searched or a database of a previously generated candidate group. A neural network composed of a directed acyclic graph (DAG) of layers may have countless combinations of architectures, but among the architectures, only the DAG structure which may process input tensors without errors may be a valid structure used for learning/prediction. Accordingly, one of the major research issues of NAS may be to generate a valid neural network structure and to define a search space which may be efficiently searched.

### SUMMARY

Example embodiments of the present disclosure is to provide a technical means related to a parser which may determine validity of an artificial neural network structure and may analyze the structure, and generation of a valid neural network architecture based the parser.

According to an example embodiment of the present disclosure, an apparatus for generating a valid neural network architecture includes one or more processors; and a memory storing one or more programs which are configured to be executed by the one or more processors. The one or more programs include instructions for a neural network architecture parser and a neural network architecture generator, which the neural network architecture parser is configured to generate one or more abstract syntax trees corresponding to neural network architectures, respectively, by parsing one or more neural network architectures; and a neural network architecture generator is configured to generate one or more new neural network architectures by substituting at least a portion of blocks of the abstract syntax tree with blocks compatible with the partial regions.

The neural network architecture parser may generate the one or more abstract syntax trees by parsing an architecture expression syntax expressing the plurality of layers included in each of the one or more neural network architectures, serial connection between the plurality of layers, and parallel merging between the plurality of layers in a predefined process calculus grammar.

The neural network architecture parser may calculate an input/output rule for each of one or more blocks included in the abstract syntax tree, and stores the calculated input/output rule and the abstract syntax tree in a first reference database.

The neural network architecture generator may identify one or more serial blocks included in each of the one or more abstract syntax trees, and stores the identified serial blocks in a second reference database.

The neural network architecture generator may amplify the serial block by applying one or more operations of block splitting, parameter mutation, and block concatenation to the identified serial block, and stores the amplified serial block in the second reference database.

The neural network architecture generator may select one of the abstract syntax trees stored in the first reference database, and may substitute a specific serial block among serial blocks included in the selected abstract syntax tree with one of the serial blocks stored in the second reference database.

The serial block to be substituted may have the same input/output rules as those of the specific serial block.

The neural network architecture generator may add an abstract syntax tree in which the specific serial block is substituted to the first reference database.

A method for generating a valid neural network architecture, performed on a computing device including one or more processors and a memory storing one or more programs executed by the one or more processors, includes generating one or more abstract syntax trees corresponding to neural network architectures, respectively, by parsing one or more neural network architectures; and generating one or more new neural network architectures by substituting at least a portion of blocks of the abstract syntax tree with blocks compatible with the partial regions.

The generating one or more abstract syntax trees may include generating the one or more abstract syntax trees by parsing an architecture expression syntax expressing a plurality of layers included in each of the one or more neural network architectures, serial connection between the plurality of layers, and parallel merging between the plurality of layers in a predefined process calculus grammar.

The generating one or more abstract syntax trees may include calculating an input/output rule for each of one or more blocks included in the abstract syntax tree, and storing the calculated input/output rule and the abstract syntax tree in a first reference database.

The generating one or more new neural network architectures may include identifying one or more serial blocks included in each of the one or more abstract syntax trees, and storing the identified serial blocks in a second reference database.

The generating one or more new neural network architectures may include amplifying the serial block by applying one or more operations of block splitting, parameter mutation, and block concatenation to the identified serial block, and storing the amplified serial block in the second reference database.

The generating one or more new neural network architectures may include selecting one of the abstract syntax trees stored in the first reference database; and substituting a specific serial block among serial blocks included in the selected abstract syntax tree with one of the serial blocks stored in the second reference database.

The serial block to be substituted may have the same input/output rules as those of the specific serial block.

The generating one or more new neural network architectures may include adding an abstract syntax tree in which the specific serial block is substituted to the first reference database.

### BRIEF DESCRIPTION OF THE DRAWINGS

The above and other aspects, features, and advantages of the present disclosure will be more clearly understood from the following detailed description, taken in combination with the accompanying drawings, in which:

FIG. 1 is a block diagram illustrating an apparatus for generating a valid neural network architecture according to an example embodiment of the present disclosure;

FIG. 2 is a diagram illustrating constraints of layers included in a neural network architecture according to an example embodiment of the present disclosure;

FIG. 3 is a diagram illustrating neural network architecture according to an example embodiment of the present disclosure;

FIG. 4 is a diagram illustrating an abstract syntax tree generated by parsing the neural network architecture illustrated in FIG. 3;

FIG. 5 is a diagram illustrating a shape transformation function of a main layer used in a convolutional neural network neural network for image processing;

FIG. 6 is a flowchart illustrating a method for generating a valid neural network architecture according to an example embodiment of the present disclosure; and

FIG. 7 is a block diagram illustrating a computing environment including a computing device suitable for use according to an example embodiment of the present disclosure.

### DETAILED DESCRIPTION

Hereinafter, embodiments of the present disclosure will be described as below with reference to the accompanying drawings. The detailed description as below may be provided to provide a comprehensive understanding of the methods, apparatus, and/or system described herein. However, this is merely an example, and the present disclosure is not limited thereto.

In describing the example embodiments of the present disclosure, when it is determined that the detailed description of a known technique related to the present disclosure may unnecessarily obscure the gist of the present disclosure, the detailed description thereof will not be provided. Also, the terms to be described later are defined in consideration of functions in the present disclosure, which may vary according to intentions or customs of a user and an operator. Accordingly, the definition should be made based on the descriptions throughout this specification. The terms used in the detailed description are to describe example embodiments of the present disclosure, and the present disclosure is not limited thereto. Unless otherwise indicated, a singular form includes a plural form in the present specification. The word “include” or “comprise” and variations such as “comprises” or “comprising,” will be understood to imply the inclusion of stated constituents, operations, operations and/or elements but not the exclusion of any other constituents, operations, operations and/or elements.

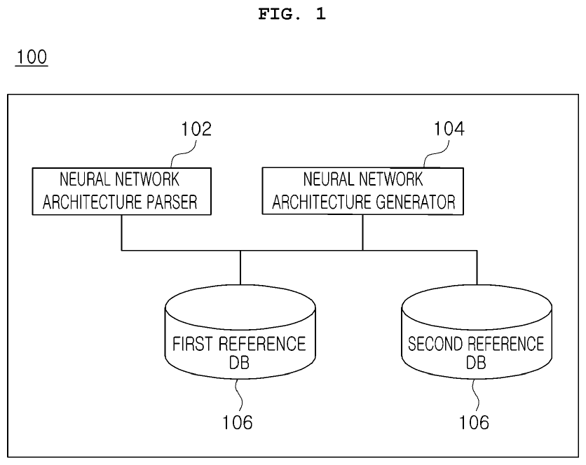

FIG. 1 is a block diagram illustrating an apparatus 100 for generating a valid neural network architecture according to an example embodiment. As illustrated in the drawings, the apparatus 100 for generating a valid neural network architecture according to an example embodiment may include a neural network architecture parser 102, a neural network architecture generator 104, a first reference database 106 and a second reference database 108.

The neural network architecture parser 102 may generate one or more abstract syntax trees corresponding to neural network architectures, respectively, by parsing one or more neural network architectures.

In order for the architecture to be valid as a neural network, input tensors may need to be processed without errors. Each layer included in the neural network architecture may act as an operator processing the input tensor, and the output tensor processed in the layer may be used as the input tensor of the subsequent connected layer. Each layer may have a constraint on the shape of an input tensor which the layer may process, and may perform learning as a neural network when the entire architecture may process the tensor without violating the above-described constraint.

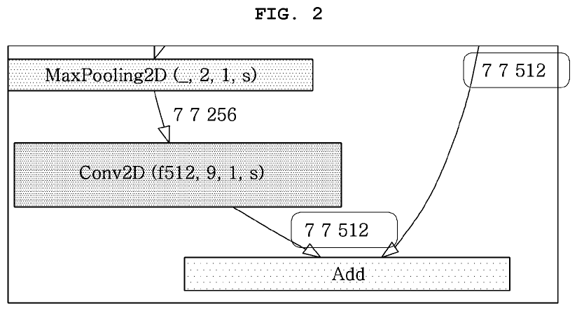

FIG. 2 is a diagram illustrating constraints of layers included in a neural network architecture according to an example embodiment. The illustrated example pertains constraints of an add layer. The add layer may be configured to receive two input tensors and to add the input tensors. In this case, the two input tensors may need to have the same shape. For example, when the shape of the tensor is defined as I=<w, h, c> (where w is a width, his a height, cis a channel of an image), the input tensors of the add layer in FIG. 2 may have the shape of <7, 7, 512>.

Merger layers such as concatenation, multiply, and the like, including the add layer, may have their own constraints on the shape of a multiple input tensor, and the shape of the input tensor may be determined by a preceding layer in the architecture. Accordingly, validity of the neural network may be determined by processing rules and constraints of included overall layers. Accordingly, in order to determine validity of the neural network architecture, it may be necessary to calculate the rules and constraints of the overall architecture by integrating the rules of the layers.

When a portion of sub-structures (blocks) of a valid architecture are substituted with another block, and the substituted block does not violate the existing rules, it may be considered that an architecture having a new structure has been created. In the example embodiment, the neural network architecture parser 102 may hierarchize the structure of the neural network architecture, may extract an entirety of sub-structures which may be substituted, and may use the parser technique to efficiently calculate the constraints or input/output rules at each layer.

In an example embodiment, the neural network architecture parser 102 may generate the one or more abstract syntax trees by parsing an architecture expression syntax expressing the plurality of layers included in each of the one or more neural network architectures, serial connection between the plurality of layers, and parallel merging between the plurality of layers in a predefined process calculus grammar. Also, the neural network architecture parser 102 may calculate an input/output rule for each of one or more blocks included in the abstract syntax tree, which will be described in greater detail as below.

A flow of information on the graph may be expressed through process calculation. Accordingly, a flow of the neural network architecture and the tensor may also be expressed through process calculation. Process calculation may be a method of expressing a concurrent system, and by defining a grammar for expressing a process, application of a parser may available. In the example embodiment, the neural network architecture parser 102 may define a grammar for describing an architecture using a process calculation for efficient architecture parsing, and may generate the expressed architecture expression syntax expressed through the defining. In an example embodiment, the grammar may include modifiers as below:
Defining single layer:
   operationName_param1_param2_ . . . _paramN
Series connection between layers or layer blocks A and B: A*B
Parallel merge of layers or layer blocks A and B: (A+B) merge_layer.

As described above, in the process calculation grammar, each layer may be defined using the name of the operation to be executed and parameters necessary for the operation, and serial connection and parallel merge may be expressed by ‘*’ and “+” operators, respectively. In this case, the merge layer may refer to merge operation layers such as add, concatenation, and multiply.

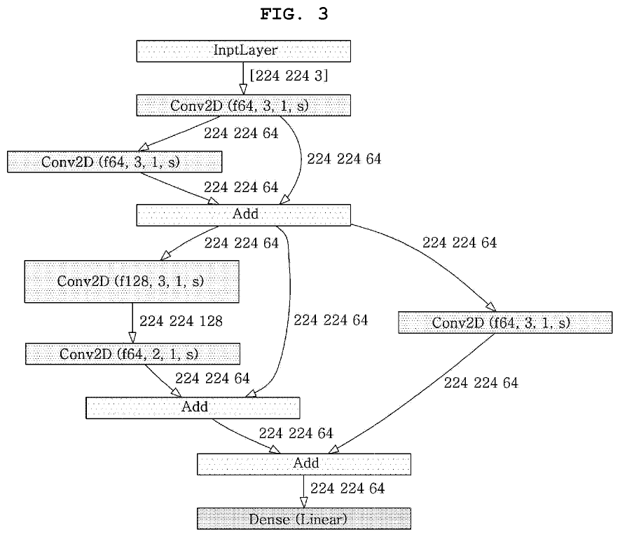

For example, a neural network architecture as illustrated in FIG. 3 may be converted into an architecture expression syntax using process calculation as below:

input
conv_32_3_2
(conv_128_3_1+skip) add
(conv_64_3_1+(conv_128_3_1*conv_64_2_1+skip) add) add
output.

In the example embodiment, a sub-structural unit of a neural network architecture may be defined as a block, and a neural network architecture may be expressed using two types of blocks including a serial connection block (Series) and a parallel merge block (Parallel). Also, the skip connection used in parallel merging may be expressed using a skip keyword. The definition of each block may be as below:

Series: Sequence of (layer|Parallel)

Parallel: Set of (Series|skip).

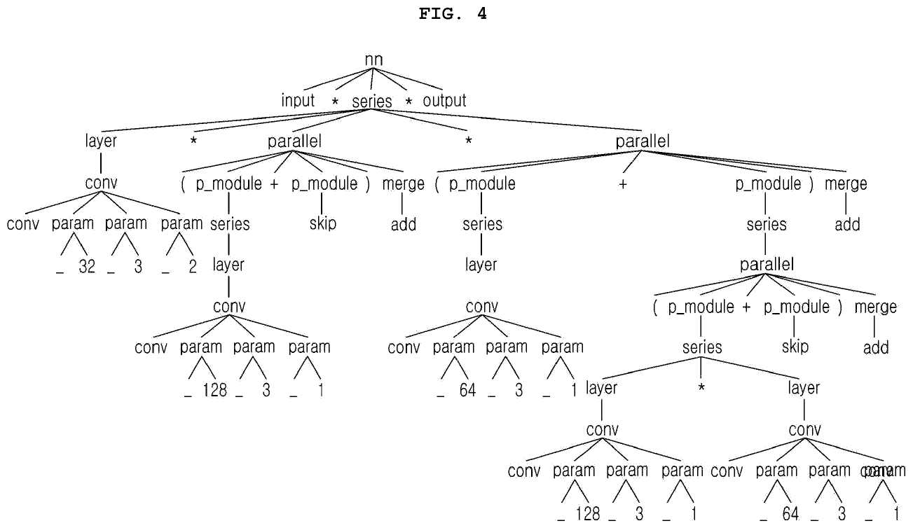

When the neural network architecture is expressed as a process calculation grammar as described above, the neural network architecture parser 102 may parse the architecture expression syntax, may check whether the provided architecture is valid through parsing, and may hierarchize the detailed structure of the valid architecture having passed the checking, thereby generating a data structure in the form of an abstract syntax tree (AST). FIG. 4 is a diagram illustrating an abstract syntax tree generated by parsing the neural network architecture shown in FIG. 3

A sub-tree having each node of the generated abstract syntax tree as a root may represent a sub-structure of the architecture, and may be used as a basic unit of change/combination to create a new architecture in the neural network architecture generator 104, which will be described later. The abstract syntax tree may include additional nodes for indicating the grammar, but in the example embodiment, the abstract syntax tree may be generated using only the nodes of the Series, Parallel, and Layer types without the additional nodes.

The neural network architecture parser 102 may calculate an input/output rule for each of one or more blocks included in the abstract syntax tree generated as above.

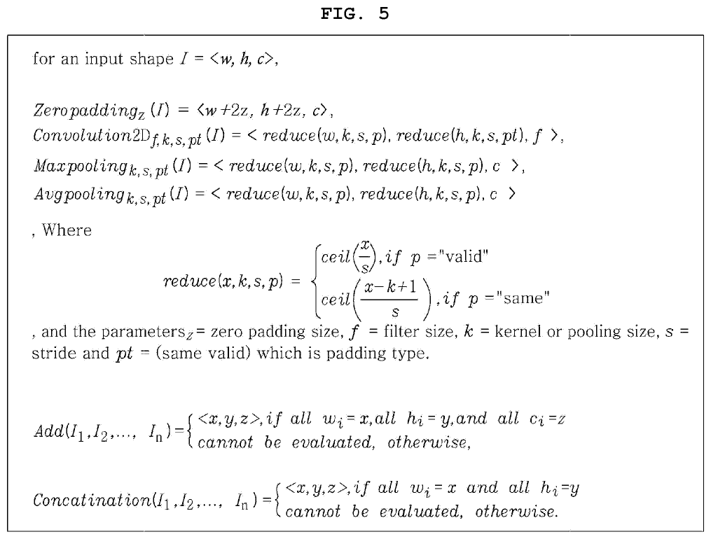

For an input tensor, each layer may transform the shape of the tensor according to the type and parameters of the layer and may generate an output tensor. Accordingly, the input/output rule of each layer may be defined as a shape conversion function of the corresponding layer. FIG. 5 is a diagram illustrating a shape transformation function of a main layer used in a convolutional neural network neural network (CNN) for image processing. The image neural network may process three-dimensional (3D) tensors, such that each function may be defined for I=<w, h, c>, which may be the shape of the 3D tensor (where w is the width, h is the height, c is the channel of the image).

Among the blocks included in the abstract syntax tree, a series block and a parallel block may have a single transform function which may be obtained by integrating transform functions of a lower layer or a lower block included in the corresponding block. Since the parallel block is defined as a merge layer such as Add, the shape conversion function of the parallel block may inherit the rules of the corresponding merge layer as is. A serial block may continuously accumulate rules of the layer to which the block belongs or a sub-block and may calculate a shape transformation function. The equation below indicates a transform function of a serial block consisting of a sequence B of layers and blocks for an input I.

Series(B,I)=<s_reduce(B,w),s_reduce(B,h),cₙ>,

where

$$s\_reduce ( B , x ) = ceil ( \frac{x + {\sum }_{i ∈ B} {q}_{i} {\prod }_{j = n}^{i - 1} {z}_{j}}{{\prod }_{i ∈ B} {x}_{i}} ) = ceil ( \frac{x ← Q}{R} ) ,$$

$${q}_{i} = \{ \begin{matrix}\begin{matrix}2 {z}_{i} , if i is a Zeropadding layer \\ 1 - {k}_{i} , if p {t}_{i} = “ same ”\end{matrix} \\ 0 , if p {t}_{i} = valid\end{matrix}$$

and cₙ is the last channel output of B.

In the s_reduce (B, I) function, Q and R may be constants determined by the defining of layers, and parameters. When two different serial blocks have the same Q and R values, and a cₙ value, the two blocks may produce the same output for the same input tensor. Accordingly, the two series blocks may have the same input/output rules, and even when the series blocks are substituted, the series blocks may not violate the input/output rules of the entire neural network architecture. Accordingly, the neural network architecture parser 102 may calculate the input/output rules of each block by calculating Q, R, and cₙ values for an entirety of blocks in a bottom-up manner from an entirety of layers included in the abstract syntax tree.

The neural network architecture parser 102 may store one or more abstract syntax trees derived through the above process and the input/output rules of each block included in each abstract syntax tree in the first reference database 106. The first reference database 106 may store and manage an abstract syntax tree for each neural network architecture generated by the neural network architecture parser 102, and an abstract syntax tree for a new neural network architecture additionally generated by the neural network architecture generator 104 to be described later. In an example embodiment, the first reference database 106 may be configured to store an abstract syntax tree generated by parsing various neural network architectures which have been previously reported.

Thereafter, the neural network architecture generator 104 may generate one or more new neural network architectures by substituting at least a portion of blocks of the abstract syntax tree stored in the first reference database 106 with blocks compatible with the partial regions. As described above, the first reference database 106 may parse and store various previously reported neural network architectures, and the neural network architecture generator 104 may generate a large amount of valid neural network architectures by transform and recombine the neural network architectures. According to the example embodiments, a new architecture which inherits and combines the characteristics of a high-performance architecture with widely recognized performance may be generated.

In an example embodiment, the neural network architecture generator 104 may identify one or more serial blocks included in an abstract syntax tree stored in a first reference database 106 and may store the identified serial blocks in a second reference database 108. The second reference database 108 may be a database which may store and manage an entirety of types of serial blocks derivable from the abstract syntax tree. The blocks stored in the second reference database 108 may be indexed into keys including <Q, R, cₙ> for swift search in the future.

The neural network architecture generator 104 may, with respect to the serial block identified from the abstract syntax tree, amplify the serial block by applying one or more operations of block splitting, parameter mutation, and block concatenation, and may store the amplified serial block in the second reference database 104.

The block splitting may be a process of generate two new serial blocks by splitting a serial block.

The parameter mutation may be a process in which a parameter of a layer within a block may generate a different new block by mutating. In this case, for the layer of which parameters are mutated, the input/output rules with the preceding and subsequent layers (or sub-blocks) of the corresponding layer may need to be compatible with each other.

Finally, the block concatenation may be a process of creating a new serial block by concatenating two serial blocks.

As such, the new block amplified and generated by the neural network architecture generator 104 may also be stored in the second reference database 104 in the form of an abstract syntax tree, and the new block may also be into a key including <Q, R, cn> for swift search in the future, similarly to the existing blocks.

Through the above-described process, the neural network architecture generator 104 may generate a block pool by generating and amplifying blocks from the abstract syntax tree. Thereafter, the neural network architecture generator 104 may generate a new architecture from the architecture stored in the first reference database 106 in the form of an abstract syntax tree using the block pool stored in the second reference database 108.

Specifically, the neural network architecture generator 104 may select one of the abstract syntax trees stored in the first reference database 106, and may select a serial block T from among the serial blocks included in the selected abstract syntax tree. In this case, the selected block may be a serial block, and a sequence of consecutive nodes among child nodes of the serial block may also be selected for various modifications. A contiguous sequence of child nodes of a particular block may logically form a new sub-serial block and may thus be selected as a substituted block.

Thereafter, the neural network architecture generator 104 may generate a new neural network architecture by substituting the selected serial block T with one of the serial blocks stored in the second reference database 108. In this case, the serial block to be substituted may need to have the same input/output rules as those of the serial block selected in the existing architecture.

Specifically, the neural network architecture generator 104 may select a block having the same key as <Q, R, cₙ> of the selected block T from the second reference database 108, may randomly select one of the searched blocks, and may substitute T with the selected block.

The abstract syntax tree in which T is substituted may be a new valid neural network architecture. Accordingly, the neural network architecture generator 104 may add the abstract syntax tree in which T is substituted to the first reference database 106.

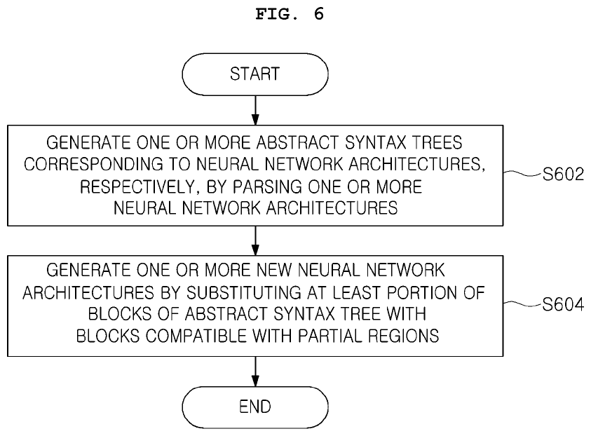

FIG. 6 is a flowchart illustrating a method 600 for generating a valid neural network architecture according to an example embodiment. The illustrated method may be performed in a computing device having one or more processors and a memory for storing one or more programs executed by the one or more processors, that is, for example, the apparatus 100 for generating a valid neural network architecture according to an example embodiment. In the illustrated flowchart, the method or process has been described by dividing the method into a plurality of operations, but at least a portion of the operations may be performed in a different order, may be performed in combination with the other operations, may not be performed, may be performed by being divided into specific operations, or may further include one or more operations not illustrated.

In operation 602, the neural network architecture parser 102 of the apparatus 100 for generating a valid neural network architecture may generate one or more abstract syntax trees corresponding to neural network architectures, respectively, by parsing one or more neural network architectures.

In operation 604, the neural network architecture generator 104 of the apparatus 100 for generating a valid neural network architecture may generate one or more new neural network architectures by substituting at least a portion of blocks of the abstract syntax tree with blocks compatible with the partial regions.

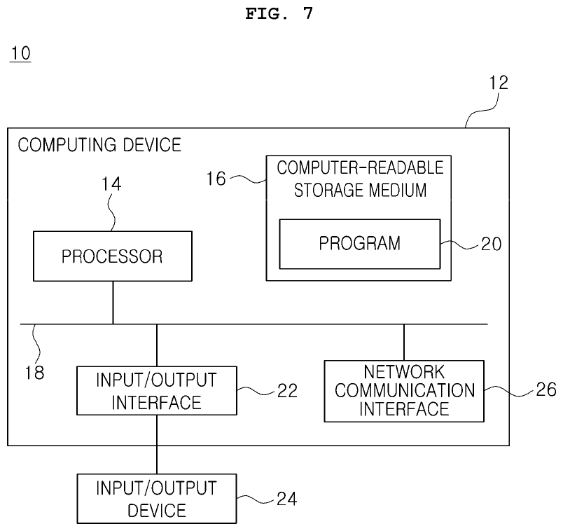

FIG. 7 is a block diagram illustrating a computing environment including a computing device suitable for use according to an example embodiment. In the illustrated example embodiment, each component may have different functions and capabilities other than those described below, and may include additional components in addition to those described below.

The illustrated computing environment 10 may include a computing device 12. In an example embodiment, the computing device 12 may be implemented as the device 100 for generating a valid neural network architecture described above.

The computing device 12 may include at least one processor 14, a computer-readable storage medium 16, and a communication bus 18. The processor 14 may allow the computing device 12 to operate in accordance with the example embodiments discussed above. For example, the processor 14 may execute one or more programs stored in the computer-readable storage medium 16. The one or more programs may include one or more computer-executable instructions, and when the computer-executable instructions are executed by the processor 14, the computing device 12 may perform operations in accordance with the example embodiments described above.

The computer-readable storage medium 16 may be configured to store computer-executable instructions or program code, program data, and/or other suitable form of information. The program 20 stored in the computer-readable storage medium 16 may include a set of instructions executable by the processor 14. In an example embodiment, the computer-readable storage medium 16 may be implemented as a memory (a volatile memory such as a random access memory, a non-volatile memory, or a suitable combination thereof), one or more magnetic disk storage devices, optical disk storage devices, flash memory devices, other forms of storage media which may be accessed by the computing device 12 and may store desired information, or a suitable combination thereof.

The communication bus 18 may interconnect various other components of computing device 12, including the processor 14 and the computer-readable storage medium 16.

The computing device 12 may also include one or more input/output interfaces 22 and one or more network communication interfaces 26 which may provide interfaces for one or more input/output devices 24. The input/output interface 22 and the network communication interface 26 may be connected to the communication bus 18. The input/output device 24 may be connected to the other components of the computing device 12 via input/output interface 22. Examples of the input/output device 24 may include a pointing device (such as a mouse or trackpad), a keyboard, a touch input device (such as a touchpad or touchscreen), a voice or sound input device, input devices such as various types of sensor devices, and/or imaging devices, and/or output devices such as a display device, a printer, a speaker and/or network card. The example input/output device 24 may be included in the computing device 12 as a component included in the computing device 12, or may be connected to the computing device 12 as a device distinct from the computing device 12.

According to the aforementioned example embodiments, by generating an abstract syntax tree by parsing the structure of the existing validated neural network architecture, and utilizing extractable sub-blocks from an entirety of layers of the generated abstract syntax tree as a basic unit of transformation and combination, structures of a variety of valid neural network architectures may be generated.

While the example embodiments have been illustrated and described above, it will be configured as apparent to those skilled in the art that modifications and variations could be made without departing from the scope of the present disclosure as defined by the appended claims.

What is claimed is:

1. An apparatus for generating a valid neural network architecture, the apparatus comprising:
one or more processors;
a memory storing one or more programs configured to be executed by the one or more processors;
the one or more programs comprising instructions for a neural network architecture parser and a neural network architecture generator;
the neural network architecture parser configured to generate one or more abstract syntax trees corresponding to one or more neural network architectures, respectively, by parsing the one or more neural network architectures; and
the neural network architecture generator configured to generate one or more new neural network architectures by substituting at least a portion of one or more blocks of the one or more abstract syntax trees with blocks compatible with the portion.

2. The apparatus of claim 1, wherein the neural network architecture parser is configured to generate the one or more abstract syntax trees by parsing an architecture expression syntax expressing in a predefined process calculus grammar a plurality of layers included in each of the one or more neural network architectures, a serial connection between the plurality of layers and a parallel merging between the plurality of layers.

3. The apparatus of claim 2, wherein the neural network architecture parser is configured to:
calculate an input/output rule for each of the one or more blocks included in the one or more abstract syntax trees; and
store the calculated input/output rule and the one or more abstract syntax trees in a first reference database.

4. The apparatus of claim 3, wherein the neural network architecture generator is configured to:
identify one or more serial blocks included in each of the one or more abstract syntax trees; and
store the identified one or more serial blocks in a second reference database.

5. The apparatus of claim 4, wherein the neural network architecture generator is configured to:
amplify the identified one or more serial blocks by applying at least one operation selected from the group consisting of block splitting, parameter mutation, block concatenation and a combination thereof; and
store the amplified serial block in the second reference database.

6. The apparatus of claim 4, wherein the neural network architecture generator is configured to:
select one of the one or more abstract syntax trees stored in the first reference database; and
substitute a first serial block among serial blocks included in the selected abstract syntax tree with a second serial block among the one or more serial blocks stored in the second reference database.

7. The apparatus of claim 6, wherein the first serial block and the second serial block have the same input/output rules.

8. The apparatus of claim 6, wherein the neural network architecture generator is configured to add an abstract syntax tree in which the first serial block is substituted to the first reference database.

9. A method for generating a valid neural network architecture, the method performed on a computing device including one or more processors and a memory storing one or more programs executed by the one or more processors, the method comprising:
generating one or more abstract syntax trees corresponding to one or more neural network architectures, respectively, by parsing the one or more neural network architectures; and
generating one or more new neural network architectures by substituting at least a portion of one or more blocks of the one or more abstract syntax trees with blocks compatible with the portion.

10. The method of claim 9, wherein the generating of the one or more abstract syntax trees comprises generating the one or more abstract syntax trees by parsing an architecture expression syntax expressing in a predefined process calculus grammar a plurality of layers included in each of the one or more neural network architectures, a serial connection between the plurality of layers and a parallel merging between the plurality of layers.

11. The method of claim 10, wherein the generating of the one or more abstract syntax trees comprises:
calculating an input/output rule for each of the one or more blocks included in the one or more abstract syntax trees; and
storing the calculated input/output rule and the one or more abstract syntax tree in a first reference database.

12. The method of claim 11, wherein the generating of the one or more new neural network architectures comprises:
identifying one or more serial blocks included in each of the one or more abstract syntax trees; and
storing the identified one or more serial blocks in a second reference database.

13. The method of claim 12, wherein the generating of the one or more new neural network architectures comprises:
amplifying the identified one or more serial blocks by applying at least one operation selected from the group consisting of block splitting, parameter mutation, block concatenation and a combination thereof; and
storing the amplified serial block in the second reference database.

14. The method of claim 12, wherein the generating of the one or more new neural network architectures comprises:
selecting one of the one or more abstract syntax trees stored in the first reference database; and
substituting a first serial block among serial blocks included in the selected abstract syntax tree with a second serial block among the one or more serial blocks stored in the second reference database.

15. The method of claim 14, wherein the first serial block and the second serial block have the same input/output rules.

16. The method of claim 14, wherein the generating of the one or more new neural network architectures comprises adding an abstract syntax tree in which the first serial block is substituted to the first reference database.
